(19) United States
(12) Patent Application Publication
(10) Pub. No.: US 2004/0058679 A1
(43) Pub. Date: Mar. 25, 2004

(54) Method for the improved cell selection for multi-mode radio stations in the idle state

(76) Inventors: Markus Dillinger, Munchen (DE); Michael Farber, Wolfratshausen (DE); Kenneth Isaacs, Dorset (GB); Jorn Krause, Berlin (DE); Christian Menzel, Maisach (DE); Bernhard Raaf, Munchen (DE); David Wynne Thomas, Hampshire (GB); Georg Wagner, Ottenhofen (DE)

Correspondence Address: STAAS & HALSEY LLP, SUITE 700, 1201 NEW YORK AVENUE, N.W., WASHINGTON, DC, 20005, US

(21) Appl. No.: 10/333,799

(22) PCT Filed: Jul. 17, 2001
(86) PCT No.: PCT/DE01/02676

(30) Foreign Application Priority Data
Jul. 25, 2000 (DE) 100 36 141.2

(51) Int. Cl. H04L 12/66

(52) U.S. Cl. 455/439; 455/450; 370/352

(57) ABSTRACT

Network information is provided for a station that is adapted to exchange data via at least one interface for each of different communication networks. The station selects an interface or a network station for exchange of data based on the network information and carries out the data exchange via the selected interface or network station. Priorities are determined and allocated to the network information of network stations or communication networks which it can receive based on their signal strength.

### CROSS REFERENCE TO RELATED APPLICATIONS

This application is based on and hereby claims priority to German Application No. 100 361 41.2 filed on Jul. 25, 2000, the contents of which are hereby incorporated by reference.

### BACKGROUND OF THE INVENTION

1. Field of the Invention

The invention relates to a method for improved cell selection for multimode radio stations in the idle state and to multimode radio stations therefor, and to a multimode radio station for carrying out such a method.

2. Description of the Related Art

In radio communications systems, information, for example speech, image information or other data, is transmitted via a radio interface between a sending station and a receiving station (base station and subscriber station) using electromagnetic waves. In this case, the electromagnetic waves are radiated at carrier frequencies which are in the frequency band provided for the respective system. For future mobile radio systems using CDMA or TD/CDMA transmission methods via the radio interface, for example the UMTS (Universal Mobile Telecommunication System), or other 3rd generation systems, frequencies in a frequency band from approximately 2000 MHz are provided.

Particularly for the subscriber station functions of cell selection, cell change (cell reselection) and transfer to an adjacent cell (handover), the subscriber station in such mobile radio systems is obliged to cyclically examine (monitor) cells around it which are suitable for cell selection or a cell change in the idle state (idle mode) and for handover in the connection state.

In the case of the currently customary GSM standard (GSM: Global System for Mobile Communication), each subscriber station in the idle state must also always find out about its surrounding conditions regarding base stations capable of communication, in order to allocate the subscriber station to a cell whose information channel carrier or BCCH carrier (BCCH: Broad Cast CHannel) it can reliably decode. If this is the case, the subscriber station is able to read system information and paging messages. Paging messages are search messages which are transmitted via the base stations in order to prompt particular subscriber stations to call back in order to set up a connection to a subscriber station from the base station end. The above also applies to UMTS in principle.

Should there be a connection request, the subscriber station has a high likelihood of communicating only in such a cell. There are then two cell selection possibilities, in particular: either that the subscriber station has no knowledge about the network or that the subscriber station has a stored list of information channel carriers.

In the unfavorable first case, the subscriber station needs to scan all the carrier frequencies, test their respective reception field strength (RXLEV) over a period of time, and form a respective mean. The carriers with the highest mean reception field strength values (RXLEV(n)) are most probably also information channel carriers, e.g. “BCCH carriers”, with transmission on these carriers being continuous, which is in turn important for testing the reception field strength.

The information channel carriers are identified finally using the frequency correction burst of the frequency correction channel. When the received information channel carriers have been found, the subscriber station synchronizes itself to each information channel carrier, starting with the carrier having the highest mean reception field strength value, and reads the system information.

On the basis of these measured values, the subscriber station selects the cell with the best reception (camping on a cell). Two criteria, the path loss criterion (C1) and the reselection criterion (C2), are defined for automatic cell selection. The ‘path loss criterion’ criterion is calculated for each cell for which it has been possible to ascertain a mean reception field strength value for its information channel carrier. Using this criterion, it is possible to ascertain the best cell with the least path loss. This is the cell for which the greatest path loss criterion can be established as being greater than zero (C1>0).

This location determination for the subscriber station can be speeded up considerably if a list of information channel carriers is stored in the subscriber's chip card (SIM—Subscriber Identification Module) or on a memory chip in the subscriber station. The subscriber station then first attempts to synchronize itself to known information channel carriers using this list. Only if it cannot find any of the stored information channel carriers does it start the normal search for a suitable information channel carrier, as described above.

When a subscriber station has committed to a cell, it needs to continue to observe all the information channel carriers quoted to it via the information channel (BA: BCCH Allocation) for as long as it is in the idle state. When it is no longer in the idle state, e.g. when a traffic channel has been used, it then monitors only the six strongest adjacent information channel carriers. This list of the six strongest adjacent information channel carriers is actually created in the idle state and is managed on a continuous basis. In line with the current standard, the subscriber station is intended to decode the information channel for the cell to which the subscriber station has committed at least every 30 seconds in this case. At least once every five minutes, all the information from the six strongest adjacent information channel carriers also needs to be read, and the base transmission/reception station identifier for these six information channel carriers needs to be ascertained at least every 30 seconds. This means that the subscriber station is able to establish any alterations in its “environment” and to react to them accordingly. In the worst case, the conditions have changed so much that it becomes necessary to reselect the cell to which the subscriber station had previously committed (cell reselection).

With the introduction of new mobile radio systems, such as UMTS-TDD or UMTS-FDD (T/FDD: Time/Frequency Division Duplex), it becomes useful to be able to operate “multimode” subscriber stations for operation under the standards GSM and/or UMTS-TDD and/or UMTS-FDD, for example. A reason for this is, inter alia, the GSM radio coverage, which is initially already broad, on the one hand, and the availability of UMTS only in conurbations, on the other.

These multimode subscriber stations are likewise intended to perform cell selection, cell changing (to idle and possible packet or connected operating state) and handover (in the connection state) under network control, with this additionally needing to be able to be done between the various radio systems as well, however. To this end, a radio access technology (RAT) selection needs to made in addition to selection of the public mobile communications network (PLMN) and cell selection/cell changing. Radio access technology, in line with RAN, is understood to mean WG2 GSM, UMTS, etc., with UMTS-TDD, UMTS-FDD (TDD and FDD) being part of the same radio access technology (RAT) but being different radio access modes, which means that they can, in principle, also be regarded as different radio access technologies for the method proposed below. To this end, existing functions need to be extended such that older subscriber stations which do not “know” these extensions are not perturbed by these extensions (problem of cross-phase compatibility). These various radio access technologies can result in the following problems:—a respective large number of cells needs to be taken into account for the various radio access technologies available at the location of a subscriber station, which results in long times for testing the reception field strengths, and

observing adjacent cells for another radio access technology is possibly associated with losses of performance in the radio access technology currently used, since subscriber station resources are used for observing adjacent cells.

### SUMMARY OF THE INVENTION

An object of the invention is to propose a method for improved cell selection for multimode radio stations and a multimode radio station therefor.

When determining the network information, particularly RAT selector lists, for subsequent access operations, cell changes or handovers, examining and considering only signals in a predetermined reception quality range, particularly only signals which satisfy particular threshold value criteria, reduces the number of signals from various receivable base and network stations and thereby rationalizes the determination process. Besides BCCH, FCCH as usable channels for determining the reception quality, it is also possible to use the common pilot channel CPICH, for example, since other RATs, such as for CDMA 2000, can be added, for example.

In particular, the time for testing the reception field strengths for the adjacent cells to a cell just prescribed as being current, or to a used cell, is reduced on account of the limited number of cells needing to be examined. Accordingly, synchronization times are also reduced on account of the limited number of cells which are to be evaluated or to be examined.

This means that sometimes only a limited number of access technologies and/or networks is then available, which means that provision is advantageously made for determining network information for available signals from further network stations and/or communications networks if the reception field strength of signals from network stations and/or communications networks with network information which is already known is below the reception quality range or if the reception field strength of signals for just a minimal number of network stations and/or communications networks with network information which is already known exceeds the reception quality range. Keeping the reception quality range configurable permits or assists such adaptability.

Storing the network information for at least selected interfaces, network stations (BS(GSM), BS(UMTS)) and/or communications networks (GSM, UMTS) used by the station for subsequent access operations reduces the length of the subsequent search for a suitable interface, particularly when a connection needs to be set up at the same location as that at which a prior connection was terminated, deliberately or as a result of reception problems, for example. The search for more suitable interfaces can generally be made using fewer resources in the station over a longer period of time, since in many cases it is possible to assume such a situation.

A subscriber station can advantageously manage a respective list of BCCH carriers for a plurality of the networks recently visited or else can allocate priorities in a different way within a list.

By controlling the content of the network information or of the RAT selector lists and using corresponding tables, the station or the network is able to control which cells are at all suitable for a cell change or handover. This thus means that not the network but ultimately the subscriber station itself is responsible for always monitoring the current reception conditions, for selecting the cells with the best reception and, with worsening conditions, suggesting all the possible access technologies and networks and their associated cells.

The time for testing the reception field strengths of the adjacent cells is reduced on account of the available knowledge about previously stored and hence quickly available network information or RAT selector lists and their cells.

The advantageous multimode radio station makes it possible to carry out such a method for providing network information while utilizing physical elements which are essentially already available.

In particular, it is a simple matter to extend cells on other or new communications systems or networks without compatibility problems with existing subscriber stations.

An exemplary embodiment is explained in more detail below with reference to the drawing, in which:

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 is a block diagram of an exemplary radio communications system with a mobile station which is situated in the area of radio cells using various radio access technologies, and

FIG. 2 is a table structure for a radio access technology or RAT selector list.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

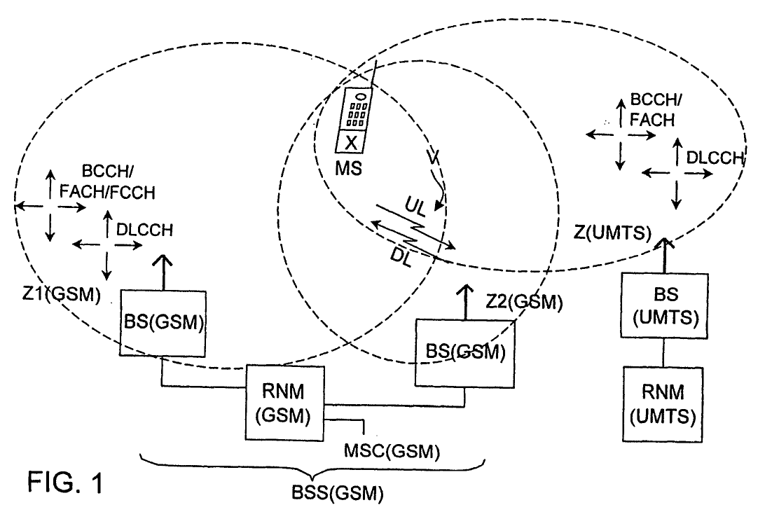

The mobile radio system shown in FIG. 1 as an example of a known radio communications system includes a multiplicity of network elements, particularly of mobile switching centers MSC, facilities for allocating radio resources RNM, base stations BS and, in the bottom hierarchical level, subscriber stations MS.

The mobile switching centers MSC networked to one another within a radio network, of which the illustration shows only one, provide access to a landline network or to another radio network. In addition, these mobile switching centers MSC are at least connected to at least one of the facilities RNM for allocating radio resources. Each of these facilities RNM in turn allows connection to at least one base station BS. Such a base station BS can set up a connection to subscriber stations, e.g. mobile stations MS or other mobile and fixed terminals, via a radio interface V. Each base station BS forms at least one radio cell (Z, Z1, Z2). With selectorization or with hierarchical cell structures, a plurality of radio cells Z can also be covered by each base station BS.

FIG. 1 shows, by way of example, existing connections V as downlinks DL and uplinks UL for transmitting user information and signaling information between a mobile subscriber station MS and the base station BS appropriately connected thereto. In addition, a respective control or organization channel (FACH or BCCH: Broadcast Control CHannel) is shown which is provided for transmitting user and signaling information at a defined transmission power from each of the base stations BS for all the mobile stations MS in the range of the corresponding radio cell Z, Z1 or Z2.

As FIG. 1 shows, the mobile subscriber station MS is in the range of three radio cells Z, Z1 and Z2. In this case, two radio cells Z1 and Z2 belong to a radio network which is operated under the GSM standard. The corresponding facilities or radio cells are identified by a bracketed index (GSM). The third radio cell Z belongs to a radio network which is operated under the UMTS standard. The corresponding network components are identified by a bracketed index (UMTS).

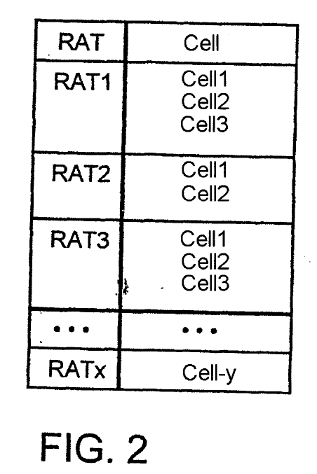

To allow the subscriber station to communicate with the base stations BS(GSM) and BS(UMTS) in the various networks, one or more separate radio access technology lists or RAT selector lists are advantageously used. The RAT selector list or RAT selection list shown by way of example in FIG. 2 has two columns. The first column lists various accessible radio networks RAT1-RATx, and the second column lists details about their individual radio cells cell1-cell-y.

For its part, this RAT selector list in turn advantageously has a priority level in terms of the radio access technology RAT1-RATx which is preferably to be used by the subscriber or his station MS. The first row containing the radio access technology RAT1 can be associated, by way of example, with a GSM network having a particular operator, the second row containing the radio access technology RAT2 can be associated, by way of example, with a UMTS network having a particular operator, and the third row containing the radio access technology RAT3 can be associated, by way of example, with another GSM network having a particular other operator. In the UMTS network, the FDD and TDD modes are a radio access technology RAT on the basis of today's standardized vocabulary. In this case, however, they can also be regarded as various radio access technologies in principle. Provided that a connection can be set up to a network using the first radio access technology RAT1, the subscriber station prefers access to this network, particularly for calls or connections emanating from the subscriber station.

Prioritization of the individual cells cell1-cell-y, which are each associated with particular access technology RAT1-RATx or network, is also advantageous. In this case, cells are allocated priority particularly on the basis of the reception field strength RXLEV-NCELL(n) and their lower path loss as compared with the current cell Z, Z1 or Z2 in an organized list of preferred cells cell1-cell-y. The reception field strength RXLEV implies that the reception level is used for the comparison. Alternatively, prioritization within one radio access technology RAT or a radio access mode would also be conceivable using another measured value, e.g. for the FDD mode the use of chip energy for each received power density in a frequency band (Ec/No).

Priorities can naturally also be allocated on the basis of selectable services.

In line with a first embodiment, such RAT selector lists can expediently be stored on the subscriber-specific chip card or “SIM” card or in a memory area X in the mobile subscriber station MS itself. Storing the last RAT used, in particular, speeds up subsequent registration after the subscriber station has been deactivated or after an existing connection has been lost.

In this case, the two possibilities again exist, in particular:

the subscriber station has no knowledge about the network or

the subscriber station has a stored RAT selector list.

In the unfavorable first case, the subscriber station needs to scan the RATs and their cells, test the respective reception field strength RXLEV and form a respective mean. The subscriber station then synchronizes itself to the individual cells, starting with the cells cell1-cell-y having the highest reception field strength value, and reads the corresponding system information.

This location determination for the subscriber station can be speeded up a great deal if, as in the second case, an RAT selector list is stored in a subscriber's SIM or directly in the subscriber station's memory X. The subscriber station then first attempts to use this RAT selector list to synchronize itself, in the case of the highest-priority RAT1 (e.g. GSM in FIG. 1), to the latter's known cells (e.g. Z1, Z2 in FIG. 1). If the mobile subscriber station finds no appropriate cells Z1, Z2, then the subscriber station repeats this for the RAT2 with the next highest priority (e.g. UMTS with cell Z in FIG. 1). Only if it cannot find any of the cells stored in the RAT selector list (cell1-cell-y) does it start the normal search.

A subscriber station MS can manage a respective dedicated RAT selector list for a plurality of the recently visited networks (PLMN).

In this case, it is advantageous to store the ascertained values or data for the recently used access technology RATx or access technologies in order to speed up future registration. If this storage is made at the highest-priority memory location in the RAT selector list, then, upon fresh registration, the subscriber station MS first attempts to register in the network or in a cell in which it was last situated, which affords a particular advantage for subscribers who predominantly stay in a fixed location.

In the simplest case, there is only one storage option which stores the last access technology used RATx or the data for a corresponding network. In an extreme case, this can be done independently of information channel access lists (BA lists). If registration with this RATx is not successful, the subscriber station MS needs to continue to work with the rest of the access technologies and/or networks RAT1-RAT3 without further prior knowledge.

This single item of stored information about the last access technology used and/or the last network used can be extended by a list containing a plurality of entries with details about visited or used access technologies RATs or networks in decreasing order of priority, until the situation in which all conceivably possible RATs are contained in this list, that is to say all the access technologies RATs or networks have an allocated priority. This naturally also covers the possibility of leaving free memory locations for holding hitherto unregistered access technologies RATs or networks.

In line with a second preferred embodiment, use is made of the fact that introducing threshold values for initiating subscriber station tests means that only a limited number of access technologies and/or networks is available.

To this end, the subscriber station cyclically tests the reception field strength RXLEV of the receivable cells, satisfying particular threshold value criteria, which belong to the highest-priority access technology RAT. If the reception field strength of these cells Z, Z1, Z2 is below a configurable threshold value or if only a minimal (configurable) number of cells Z, Z1, Z2 exceed this configurable threshold value, the subscriber station MS will test all available access technology RATs and/or networks and their cells Z, Z1, Z2, or at least further RATs, until a sufficient number of cells Z, Z1, Z2 have been found. This naturally also applies accordingly if the minimal number is not reached.

This thus means that not the network but rather the subscriber station MS itself is responsible for always monitoring the current reception conditions, for selecting the cells with the best reception and, with worsening conditions, for testing all available access technologies RATs or networks and their associated cells Z, Z1, Z2. The results can then be buffer-stored or stored in a RAT list or RAT selector list.

The contents of these RAT selector lists can, in principle, also be changed dynamically during operation, in which case the change cycles should advantageously be no shorter than a few seconds. One criterion for the length of such change cycles is, by way of example, the size of the cells and the speed at which the subscriber station MS is usually or actually moved through such a cell Z, that is to say the dwell time in the range of a cell Z. Another basis for these changes could be, by way of example, the traffic load, with overloaded adjacent cells being removed from the adjacent cell list and therefore no longer being selected by moving subscriber stations. In addition, an RAT change instructed by the network, bypassing the above condition, is also possible.

The lists for the idle state and the connection state can also be created differently, which can also be provided for on a subscriber-station-specific basis and/or in a similar manner to GSM. With regard to this invention, this results, by way of example, in the transmission of information which is not needed being avoided by virtue of the subscriber station MS in the connection state sending only the adjacent cell lists for the systems and/or networks which the subscriber station MS actually supports or can support. This affords the opportunity for subscriber-specific preselection of the adjacent cell lists.

This embodiment thus makes use of the fact that introducing threshold values for initiating subscriber station tests means that only a limited number of access technologies and/or networks is available.

In the simplest case, there is just one storage option in this context, which stores the last access technology RAT used and/or the last network used. If tests therein are not successful, the subscriber station MS needs to carry out tests for the rest of the access technologies RAT or networks without other prior knowledge.

This single item of memory information can be extended by a list containing a plurality of entries with access technologies RATs or networks in decreasing order of priority. In this case, the tests are continued until an adequate number of cells have been found.

In general, the selection of an access technology RAT or of a particular communications network within an access technology RAT can optionally also be made dependent on requested services, for example. Thus, communication via an inexpensive GSM network can suffice for a voice link, whereas a connection using an expensive UMTS communications network would be preferred for a high-rate data link.

The invention has been described in detail with particular reference to preferred embodiments thereof and examples, but it will be understood that variations and modifications can be effected within the spirit and scope of the invention.

1. A method for providing network information (RAT1-RATX, cell1-cell-y) for a station (MS),
which, when required, interchanges data via at least one interface (V) in a network station (BS) in one of various communications networks (GSM, UMTS),
which uses the network information (RAT1-RATX, cell1-cell-y) to select an interface (V) or network station (BS) for interchanging data,
which manages the interchange of data via the selected interface (V) or network station (BS), and
which determines network information (RAT1-RATX, cell1-cell-y) for network stations (BS(GSM), BS(UMTS)) and/or communications networks (GSM, UMTS) which it can receive on the basis of the reception quality of the latter's signals (BCCH, FCCH),
characterized in that
determining the network information (RAT1-RATX, cell1-cell-y) for subsequent access operations, cell changes or handovers involves only signals in a predetermined reception quality range being examined, particularly only signals (BCCH, FCCH) which satisfy particular threshold value criteria being examined.

2. The method as claimed in claim 1, in which network information (RAT1-RATx, cell1-cell-y) for available signals from further network stations (BS(GSM), BS(UMTS)) and/or communications networks (GSM, UMTS) is determined if the reception field strength of the signals from a, in particular configurable, number of network stations (BS(GSM), BS(UMTS)) and/or communications networks (GSM, UMTS) with network information (RAT1-RATX, cell1-cell-y) which is already known is below the reception quality range.

3. The method as claimed in claim 1 or 2, in which network information (RAT1-RATX, cell1-cell-y) for available signals from further network stations (BS(GSM), BS(UMTS)) and/or communications networks (GSM, UMTS) is determined if the reception field strength of the signals from just a minimal number of network stations (BS(GSM), BS(UMTS)) and/or communications networks, (GSM, UMTS) with network information (RAT1-RATX, cell1-cell-y) which is already known is below the reception quality range.

4. The method as claimed in a preceding claim, in which the reception quality range can be configured, in particular can be progressively extended from a standard value if the number of network stations (BS(GSM), BS(UMTS)) and/or communications networks (GSM, UMTS) which can be used is too small.

5. A method for providing network information (RAT1-RATX, cell1-cell-y) for a station (MS), particularly as claimed in one of the preceding claims, where the station (MS)
when required, interchanges data via at least one interface (V) in a network station (BS) in one of various communications networks (GSM, UMTS),
uses the network information (RAT1-RATX, cell1-cell-y) to select an interface (V) or network station (BS) for interchanging data, and
manages the interchange of data via the selected interface (V) or network station (BS),
characterized in that
the network information (RAT1-RATX, cell1-cell-y) for at least selected interfaces (V), network stations (BS(GSM), BS(UMTS)) and/or communications networks (GSM, UMTS) used by the station (MS) is stored for subsequent access operations.

6. The method as claimed in a preceding claim, in which the last network information (RAT1-RATX, cell1-cell-y) used is stored.

7. The method as claimed in a preceding claim, in which at least some of the network information (RAT1-RATX, cell1-cell-y) is stored in updatable form, in particular is buffer-stored in overwritable form.

8. The method as claimed in a preceding claim, in which the network information (RAT1-RATX, cell1-cell-y) is stored in the station (MS) or on a data storage medium which can be used in the station (MS).

9. The method as claimed in a preceding claim, in which the network information (RAT1-RATX, cell1-cell-y) stored is access data relating to various accessible radio networks (RAT1-RATX) and/or individual radio cells (cell1-cell-y).

10. The method as claimed in a preceding claim, in which, in the event of a lack of suitable stored network information (RAT1-RATX, cell1-cell-y), the station (MS) examines further available interfaces (V), cells (Z, Z1, Z2), network stations (BS(GSM), BS(UMTS)) and/or communications networks (GSM, UMTS) for their suitability for connection setup.

11. The method as claimed in a preceding claim, in which the network information (RAT1-RATX, cell1-cell-y) is changed dynamically during operation.

12. The method as claimed in a preceding claim, in which the network information (RAT1-RATX, cell1-cell-y) is given different priorities for the idle and connection states and/or for various services and/or is given priorities within available radio access technologies (RAT1-RATX) and/or radio cells (cell1-cell-y; Z, Z1, Z2).

13. A multimode radio station (MS), particularly for carrying out a method for providing network information (RAT1-RATX, cell1-cell-y) as claimed in a preceding claim,
where the radio station (MS) has
a transmission and reception device for interchanging data in each case via at least one interface (V) in a network station (BS) in various communications networks (GSM, UMTS) when required,
a selection device for prioritized determination and/or selection of an interface (V) and/or network station (BS) on the basis of the latter's network information (RAT1-RATX, cell1-cell-y) for interchanging data, and
a memory device (X) for storing network information (RAT1-RATX, cell1-cell-y),
characterized in that
the memory device (X) is provided with a storage space for storing the network information (RAT1-RATX, cell1-cell-y) for at least selected interfaces (V), network stations (BS(GSM), BS(UMTS)) and/or communications networks (GSM, UMTS) used by the station (MS) for subsequent access operations, and/or
the selection device is designed for determining the network information (RAT1-RATX, cell1-cell-y) for subsequent access operations, cell changes and/or handovers on the basis of signals (BCCH, FCCH) in a predetermined reception quality range.
